(19) United States
(12) Patent Application Publication
(10) Pub. No.: US 2016/0008952 A1
(43) Pub. Date: Jan. 14, 2016

(54) METHODS AND SYSTEMS FOR THREE-DIMENSIONAL FLUID JET CUTTING

(71) Applicant: General Electric Company, Schenectady, NY (US)

(72) Inventors: Yuanfeng Luo, Rexford, NY (US); Erik Karl Jacobson, Pattersonville, NY (US); Jane Marie Lipkin, Niskayuna, NY (US); Jeremy Gordon McNamara, Albany, NY (US); Donovan Orlando Buckley, Delmar, NY (US)

(21) Appl. No.: 14/327,188

(22) Filed: Jul. 9, 2014

(51) Int. Cl. B24C 1/04; G05B 19/402

(52) U.S. Cl. CPC B24C 1/045; G05B 19/402; G05B 2219/35013; G05B 2219/41169

(57) ABSTRACT

A computer-implemented method for forming a three-dimensional workpiece from a block of material using a fluid jet cutting device is implemented by a fabrication system. The method includes receiving an indication of the geometry of the workpiece and generating a three-dimensional tool path to control a cutting head to form the workpiece. Generating the tool path includes receiving an indication of a desired cutting surface on the workpiece, determining a length of the cutting surface, and designating a plurality of waypoints along an edge of the cutting surface. Generating the tool path also includes determining at least one geometric parameter of the cutting surface at each waypoint of the plurality of waypoints, and calculating a speed of the cutting head at each waypoint of the plurality of waypoints based on the determined geometric parameter such that the speed of the cutting head varies along the cutting surface length.

### BACKGROUND

The field of the disclosure relates generally to methods and systems for fabricating components, and more specifically to fabricating three-dimensional components using a fluid jet cutting system.

Manufacturing processes for use in fabricating at least some known components, for example gas turbine engine components, use a system of Computer Aided Design (CAD) and Computer Aided Manufacturing (CAM). A CAD solid model is first developed to emulate the desired geometry of the component, and then a tool path using CAM software is developed for use by a 5-axis milling machine. In at least some known manufacturing process, a solid block of material, for example at least one of titanium, aluminum, and steel, is subjected to an initial roughing process, such as wire electrical discharge machining (EDM), before machining of the component is completed by the milling machine. The EDM process removes a portion of the material to shape the block material a semblance of the CAD model before finishing in the milling machine.

However, at least some known EDM processes are either not able to machine components in three dimensions or to do at an extremely slow speed. Further, such EDM processes are only able to remove approximately one quarter of the total material to be removed. As such, the milling machine is left to remove a majority of the material from the block to fabricate the component, which will increase the wear on the milling machine and, therefore, decrease the operational service life of the milling machine. Furthermore, because at least some known milling machines are tuned to precise tolerances and have relatively small cutting surfaces, removal of a substantial amount of material requires an extended period of time. For example, machining of at least one known turbine engine component using the milling machine requires approximately 600 minutes for completion. As such, only a limited number of components are able to be fabricated over a specified duration. As such, the extensive operating time and milling machine replacement costs increase the fabrication expenses of using a milling machine to fabricate the components.

### BRIEF DESCRIPTION

In one aspect, a computer-implemented method for forming a workpiece from a block of material is provided. The method uses a workpiece fabrication system including a fluid jet cutting device having a cutting head and a cutting jet. The workpiece fabrication system further including a processor and a memory device coupled to the processor. The method includes receiving a computer generated model of the workpiece and generating a three-dimensional tool path to control a cutting head to form the workpiece. Generating the tool path includes identifying a desired cutting surface on the workpiece, determining a length of the cutting surface, and designating a plurality of waypoints along an edge of the cutting surface. Generating the tool path also includes determining at least one geometric parameter of the cutting surface at each waypoint of the plurality of waypoints, and calculating a speed of the cutting head at each waypoint of the plurality of waypoints. The cutting speed is based on the determined geometric parameter such that the speed of the cutting head varies along the cutting surface length.

In another aspect, a workpiece fabrication system is provided. The workpiece fabrication system includes a fluid jet cutting device including a cutting head configured to generate a cutting jet of predetermined medium and to form at least a portion of a workpiece with the cutting jet. The workpiece fabrication system also includes a processor coupled to the fluid jet cutting device, wherein the processor is configured to receive an indication of the geometry of the workpiece, receive an indication of a desired cutting surface on the workpiece, and determine a length of the cutting surface. The processor is further configured to designate a plurality of waypoints along an edge of the cutting surface and determine at least one geometric parameter of the cutting surface at each waypoint of the plurality of waypoints. The processor then calculates a speed of the cutting head at each waypoint of the plurality of waypoints based on the determined geometric parameter such that the speed of the cutting head varies along the cutting surface length.

In yet another aspect, one or more computer-readable storage media having computer-executable instructions embodied thereon is provided. When executed by at least one processor, the computer-executable instructions cause the at least one processor to receive an indication of a geometry of a workpiece, receive an indication of a desired cutting surface on the workpiece, and determine a length of the cutting surface. The computer-executable instructions further cause the at least one processor to designate a plurality of waypoints along an edge of the cutting surface and determine a geometric parameter of the cutting surface at each waypoint of the plurality of waypoints. The processor then calculates a speed of a cutting head at each waypoint of the plurality of waypoints based on the determined geometric parameter such that the speed of the cutting head varies along the cutting surface length.

### DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an exemplary fabrication system used to form a workpiece;

FIG. 2 is a block diagram of an exemplary computing device that is used in the fabrication system shown in FIG. 1;

FIG. 3 is a perspective view of an exemplary workpiece produced using the fabrication system shown in FIG. 1;

FIG. 4 is a flow chart of an exemplary process for controlling the fabrication system shown in FIG. 1 to produce the workpiece;

FIG. 5 is a perspective view of the workpiece shown in FIG. 3 generated by designating a plurality of waypoints along an edge of a cutting surface on the workpiece;

FIG. 6 is a continuation of the method from FIG. 4;

FIG. 7 is a perspective view of the workpiece shown in FIG. 3 produced by generating an orientation vector at each waypoint designated in FIG. 5; and

FIG. 8 is a continuation of the method from FIG. 6.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations are combined and interchanged, such ranges are identified and include all the sub-ranges contained therein unless context or language indicates otherwise.

As used herein, the terms “processor” and “computer” and related terms, e.g., “processing device”, “computing device”, “central processing unit (CPU)”, and “controller” are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein are encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The terms “high-pressure fluid jet” and “cutting jet” used throughout should be understood to incorporate all types of high-pressure fluid jets, including but not limited to, high-pressure waterjets and high-pressure abrasive waterjets. In such systems, high-pressure fluid, typically water, flows through an orifice in a cutting head to form a high-pressure jet, into which abrasive particles are combined as the jet flows through a mixing tube. The high-pressure abrasive waterjet is discharged from the mixing tube and directed toward a workpiece to cut the workpiece along a designated path.

Although discussed herein in terms of waterjets, and abrasive waterjets in particular, the described techniques can be applied to any type of fluid jet, generated by high pressure or low pressure, whether or not additives or abrasives are used. In addition, these techniques can be modified to control the x-axis, y-axis, z-offset, and tilt and swivel (or other comparable orientation) parameters as functions of process parameters other than speed, and the particulars described herein.

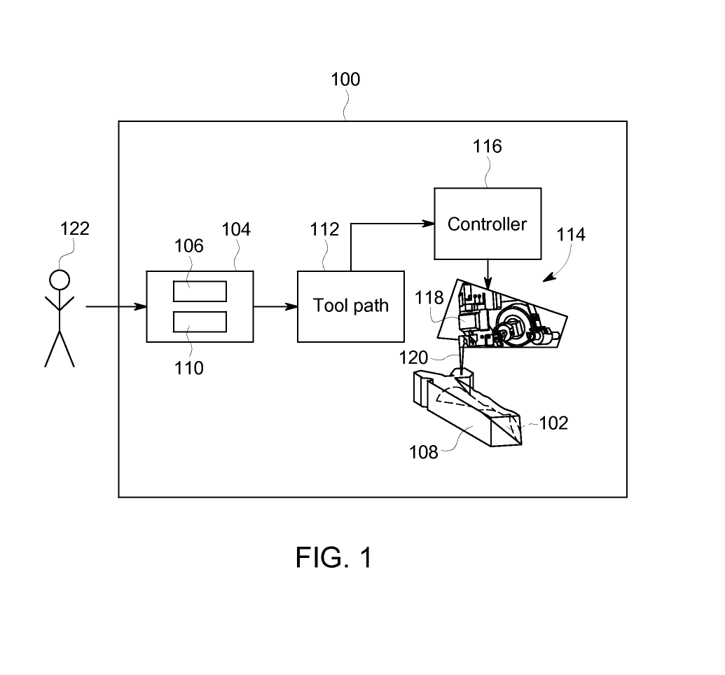

FIG. 1 is a block diagram illustrating a fluid jet fabrication system 100 used to at least partially produce a workpiece 102. Fluid jet fabrication system 100 includes a central processing unit (CPU) 104 having a CAD program 106 or package (or CAD/CAM program or package) to generate a computerized model of workpiece 102 (e.g., a part) to be cut from a block of material 108. In the exemplary embodiment, CPU 104 includes a tool path generation system 110 configured to generate a tool path 112, based on the computerized model, that facilitates fabrication of workpiece 102. Fluid jet fabrication system 100 further includes a fluid jet cutting device 114 that is communicatively coupled to CPU 104. In the exemplary embodiment, fluid jet cutting device 114 is an abrasive water jet cutting device. Alternatively, fluid jet cutting device 114 is any fluid cutting device. Fluid jet cutting device 114 includes a hardware/software controller 116, such as but not limited to, a computer numeric controller (CNC), configured to control a cutting head 118 of device 114 from which a cutting jet 120 of high-pressure fluid extends to fabricate workpiece 102. In the exemplary embodiment, any existing CAD program or package can be used to generate the computerized model of workpiece 102 providing it facilitates operation of fluid jet fabrication system 100 as described herein. Further, the CAD design package also may be incorporated into tool path generation system 110 itself.

In the exemplary embodiment, tool path generation system 110 resides within CPU 104 separate from, but communicatively coupled to, fluid jet cutting device 114. Alternatively, tool path generation system 110 is located on other devices within fabrication system 100. For example, tool path generation system 110 may be embedded in controller 116 of fluid jet cutting device 114 as part of the software/firmware/hardware associated with device 114. All such combinations or permutations are contemplated, and appropriate modifications to tool path generation system 110 described, such as the specifics of tool path 112 and its form, are contemplated based upon the particulars of fabrication system 100 and associated control hardware and software.

In operation, a user 122 uses CAD program 106 to generate the computerized model of workpiece 102 on CPU 104. The computer-generated model is then input into the tool path generation system 110, which then automatically generates, as described in further detail below, tool path 112 (or other programmatic or other motion related data) that specifies how cutting head 118 is to be controlled to cut workpiece 102 from block 108. In the exemplary embodiment, tool path generation system 110 communicates tool path 112 to controller 116, which controls cutting head 118 to cut block 108 according to the instructions contained in tool path 112 to produce workpiece 102. As such, tool path generation system 110 provides a Computer-Aided Manufacturing process (CAM) to produce workpieces 102.

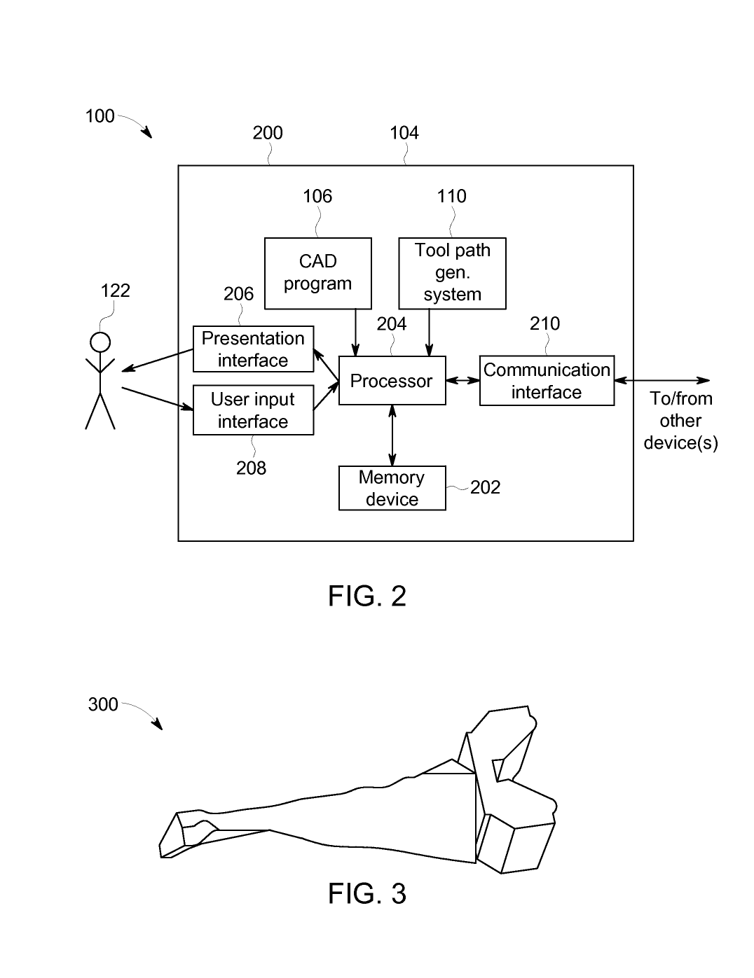

FIG. 2 is a block diagram of an exemplary computing system 200, such as CPU 104 (shown in FIG. 1), used in fabrication system 100 to generate tool path 112 (shown in FIG. 1). Alternatively, any computer architecture that enables operation of the systems and methods as described herein is used. Computing system 200 facilitates collecting, storing, analyzing, displaying, and transmitting data and operational commands associated with configuration, operation, monitoring and maintenance of components in fabrication system 100 such as fluid jet cutting device 114 and its associated controller 116 (both shown in FIG. 1).

Also, in the exemplary embodiment, computing system 200 includes a memory device 202 and a processor 204 operatively coupled to memory device 202 for executing instructions. In some embodiments, executable instructions are stored in memory device 202. Computing system 200 is configurable to perform one or more operations described herein by programming processor 204. For example, processor 204 is programmed by encoding an operation as one or more executable instructions and providing the executable instructions in memory device 202. Processor 204 may include one or more processing units, e.g., without limitation, in a multi-core configuration.

Further, in the exemplary embodiment, memory device 202 is one or more devices that enable storage and retrieval of information such as executable instructions and other data. Memory device 202 may include one or more tangible, non-transitory computer-readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and non-volatile RAM (NVRAM) memory. The above memory types are exemplary only, and are thus not limiting as to the types of memory usable for storage of a computer program.

In some embodiments, computing system 200 includes a presentation interface 206 coupled to processor 204. Presentation interface 206 presents information, such as a user interface and an alarm, to user 122. For example, presentation interface 206 may include a display adapter (not shown) that is coupled to a display device (not shown), such as a cathode ray tube (CRT), a liquid crystal display (LCD), an organic LED (OLED) display, and a hand-held device with a display. In some embodiments, presentation interface 206 includes one or more display devices.

In some embodiments, computing system 200 includes a user input interface 208. In the exemplary embodiment, user input interface 208 is coupled to processor 204 and receives input from user 122. User input interface 208 may include, for example, a keyboard, a pointing device, a mouse, a stylus, and a touch sensitive panel, e.g., a touch pad or a touch screen. A single component, such as a touch screen, may function as both a display device of presentation interface 206 and user input interface 208.

Further, a communication interface 210 is coupled to processor 204 and is configured to be coupled in communication with one or more other devices such as, without limitation, components in fabrication system 100, another computing system 200, one or more controllers and control devices, and any device capable of accessing computing system 200 including, without limitation, a portable laptop computer, a personal digital assistant (PDA), and a smart phone. Specifically, communication interface 210 is configured to communicate tool path 112 from tool path generation system in computing system 200 to controller 116 of fluid jet cutting device 114. Communication interface 210 may include, without limitation, a wired network adapter, a wireless network adapter, a mobile telecommunications adapter, a serial communication adapter, and a parallel communication adapter. Communication interface 210 may receive data from and transmit data to one or more remote devices. Computing system 200 may be web-enabled for remote communications, for example, with a remote desktop computer (not shown).

Also, presentation interface 206 and communication interface 210 are both capable of providing information suitable for use with the methods described herein, e.g., to user 122 or another device. Accordingly, presentation interface 206 and communication interface 210 are referred to as output devices. Similarly, user input interface 208 and communication interface 210 are capable of receiving information suitable for use with the methods described herein and are referred to as input devices.

Further, processor 204 and memory device 202 may also be operatively coupled to CAD program 106 and tool path generation system 110. CAD program 106 may be external to tool path generation system 110, as shown in FIG. 2, or CAD program 106 may be incorporated into tool path generation system 110. Tool path generation system 110 receives input from CAD program 106 and from user 122 via user interface 208 to generate tool path 112 that can be communicated to and executed by controller 116 to control cutting head 118 (shown in FIG. 1).

In the exemplary embodiment, tool path generation system 110 includes one or more functional components/modules that work together to generate tool path 112 to cut workpiece 102. The component/modules of tool path generation system 110 determine appropriate cutting head 118 orientation and cutting process parameters, such as travel speed, that control cutting head 118. More specifically, the component/modules of tool path generation system 110 determine the x-axis, y-axis, and z-axis positions of cutting head 118 and angular orientations of cutting jet 120 relative to block 108 being cut. These components are implemented in software, firmware, or hardware or a combination thereof.

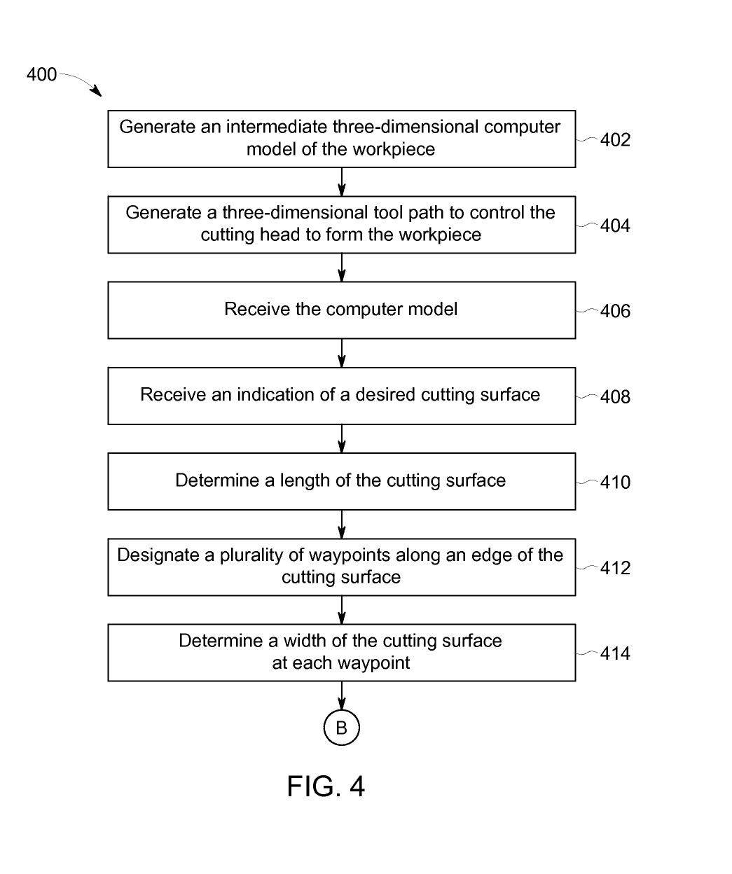

FIG. 3 is an illustration of an exemplary workpiece 300 produced using fabrication system 100. In the exemplary embodiment, workpiece 300 is an airfoil structure for use in a turbine engine. Alternatively, workpiece 300 is any component that facilitates operation of fabrication system 100 as described herein. FIG. 4 is a flow diagram of an exemplary method 400 for controlling fabrication system 100 (shown in FIG. 1) to produce workpiece 300. The fabrication method 400 begins with generating 402 an intermediate three-dimensional computer-generated model of workpiece 300. The computer-generated model is a representation of the geometry of workpiece 300 after fabrication from fluid jet cutting device 114 and before workpiece 300 is machined to its final desired dimensions in a milling machine (not shown). The intermediate model is generated based on a final model of workpiece 300 that includes the final geometry dimensions after milling when workpiece 300 is complete. To generate the intermediate model of workpiece 300 from the final model, user 122 (shown in FIG. 1) utilizes CAD program 106 to rebuild the final model by adding layers to increase various dimensions of the final model. This represents adding material from block of material 108 (shown in FIG. 1) to the surfaces of the final machined workpiece to increase at least one of the depth, thickness, and length of final workpiece.

Once the intermediate model is generated, the next step in method 400 is to generate 404 a three-dimensional tool path, such as tool path 112 (shown in FIG. 1) to control cutting head 118 (shown in FIG. 1) to form workpiece 300. As described above, tool path 112 is generated by user 122 on CPU 104 using tool path generation system 110 (shown in FIG. 1). Tool path generation system 110 accesses or receives 406 the intermediate model of workpiece 300 from CAD program 106 and displays the model to user 122 on presentation interface 206 (shown in FIG. 1).

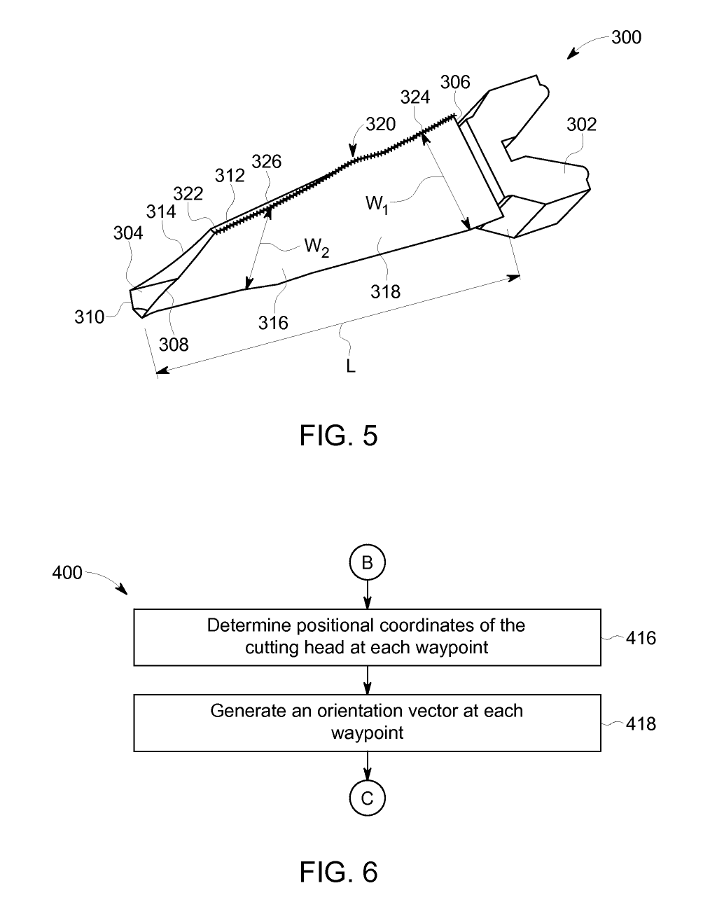

FIG. 5 is a perspective view of the intermediate model of workpiece 300 as displayed on presentation interface 206. In the exemplary embodiment, workpiece 300 includes a dovetail portion 302 and an airfoil portion 304. Airfoil portion 304 includes a first end 306 defined at a base of airfoil portion 304 proximate dovetail portion 302, a second end 308 defined at a tip of airfoil portion 304, and a length L defined as the distance between ends 306 and 308. In the exemplary embodiment, airfoil portion 304 also includes a leading edge 310, a trailing edge 312, a first surface 314, and an opposing second surface 316, wherein first and second surfaces 314 and 316, respectively, each extend between leading and trailing edges 310 and 312, respectively. Alternatively, airfoil portion 304 may have any number of sides and edges that facilitate operation of fabrication system 100 as described herein.

Referring back to FIG. 4, method 400 of forming workpiece 300 further includes indicating a desired cutting surface on the model of workpiece 300. More specifically, tool path generation system 110 receives 408 an indication of the desired cutting surface from user 122 through user input interface 208 (shown in FIG. 1). Such an indication may include selecting a surface on the model itself, selecting a named surface from a list of available surfaces, or any other manner of indicating a surface of workpiece 300. In the exemplary embodiment, as shown in FIG. 5, second surface 316 is indicated as the cutting surface 318. Once desired cutting surface 318 has been received by tool path generation system 110, the length L of cutting surface is determined 410 and stored in memory device 202 (shown in FIG. 2). In the exemplary embodiment, cutting surface 318 has length L between first end 306 and second end 308 of airfoil portion 304. Method 400 continues with tool path generation system 110 allocating 412 a plurality of waypoints on an edge of cutting surface 318 along the determined length L. As shown in FIG. 5, a plurality of waypoints 320 is designated along a boundary edge 322 of cutting surface 318. More specifically, waypoints 320 are evenly spaced along edge 322 between first end 306 and second end 308. In the exemplary embodiment, waypoints 320 are distributed with a predetermined spacing density such that the plurality of waypoints 320 form a substantially solid line along edge 322 of cutting surface 318. Alternatively, waypoints 320 have any spacing density that facilitates operation of fabrication system 100 as described herein.

Cutting surface 318 also includes a width W defined between leading edge 310 and trailing edge 312. Width W varies along length L of cutting surface 318 between first end 306 and second end 308. More specifically, cutting surface 318 includes a first width W₁ at a first waypoint 324 proximate first end 306 and a second width W₂ at a second waypoint 326 proximate second end 308. In the exemplary embodiment, width W₁ is greater than width W₂. Referring back to FIG. 4, after waypoints 320 are allocated along edge 322, tool path generation system 110 then determines 414 at least one geometric parameter of cutting surface 318 at each waypoint 320 and stores the geometric parameter in memory device 202. In the exemplary embodiment, the geometric parameter determined by tool path generation system is the width of cutting surface 318 between leading edge 310 and trailing edge 312 at each waypoint 320. For example, tool path generation system 110 determines that the width of cutting surface 318 at first waypoint 324 is width W1. Alternatively, tool path generation system 110 may determine any geometric parameter that facilitates operation of fabrication system 100 as described herein.

FIG. 6 is a continuation of method 400 from FIG. 4. Method 400 continues with tool path generation system 110 determining 416 a three-dimensional set of positional coordinates associated with cutting head 118 (shown in FIG. 1) and then storing the positional coordinates in memory device 202. More specifically, tool path generation system 110 determines a unique set of X,Y,Z positional coordinates for each waypoint of the plurality of waypoints 320 along edge 322 of cutting surface 318.

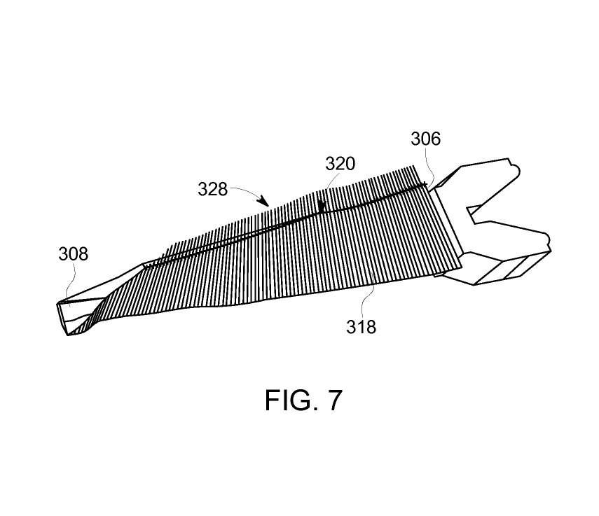

Similarly, tool path generation system 110 also generates 418 an orientation vector 328 at each waypoint of the plurality of waypoints 320. As shown in FIG. 7, each orientation vector 328 is representative of an orientation of cutting jet 120 (shown in FIG. 1). Tool path generation system 110 determines a set of I, J, K orientation coordinates for each waypoint 320 to control the orientation of cutting jet 120 such that cutting jet 120 is parallel to cutting surface 318 at each waypoint 320. Once the orientation coordinates are determined by tool path generation system 110, the orientation coordinates are stored in memory device 202. In the exemplary embodiment, cutting surface 318 has a twisted orientation and therefore is not continuously planar between first and second ends 306 and 308. As such, tool path generation system 110 determines a unique set of I, J, K coordinates for each waypoint 320 because the orientation of cutting jet 120 changes at each waypoint 320. Alternatively, in cases where the cutting surface is a continuously planar surface, or includes at least a portion that is continuously planar, then the orientation of cutting jet 120 would not change, and the I, J, K coordinates would be the same for each waypoint having the same orientation.

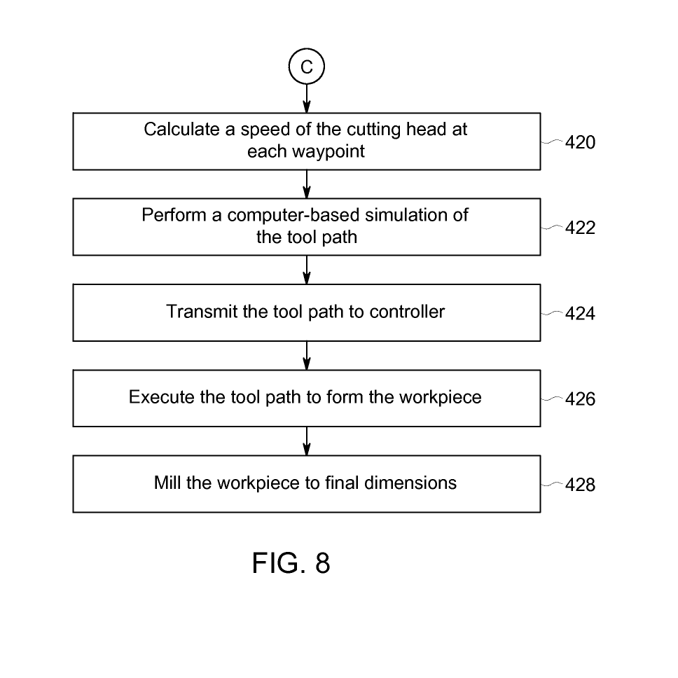

FIG. 8 is a continuation of method 400 from FIG. 6. Once tool path generation system 110 determines the width of cutting surface 318 at each waypoint and generates the positional and orientation coordinates of cutting head 118 and cutting jet 120, respectively, it then calculates 420 the travel speed of cutting head 118 at each waypoint 320 based on the width of cutting surface 318 at that waypoint 320. More specifically, tool path generation system 110 calculates the travel speed of cutting head 118 at each waypoint 320 based on the width of cutting surface 318 at that waypoint 320 such that the travel speed of cutting head 118 varies along length L of cutting surface 318. The maximum allowable travel speed of cutting head 118 is the speed at which cutting head 118 is able to travel along length L and still cut the entire width of cutting surface 318 with a desired surface quality. As such, the speed at which cutting head 118 is able to travel through each waypoint 320 is dependent on the width of cutting surface 318 at that particular waypoint 320. The shorter the width of cutting surface at a certain waypoint, the faster the speed at which cutting head 118 is able to travel through that that waypoint 320 to complete the cut.

For example, referring to FIG. 5, cutting surface 318 has first width W₁ at first waypoint 324. Tool path generation system 110 calculates that cutting head 118 is able to travel at a first speed through waypoint 324 to complete the cut across width W₁. Similarly, cutting surface 318 has second width W₂ at second waypoint 326. Tool path generation system 110 calculates that cutting head 118 is able to travel at a second speed through waypoint 326 to complete the cut across width W₂. Since width W₂ is shorter than W₁, cutting head 118 is able to travel at a faster second speed through waypoint 326 than through waypoint 324. Varying the travel speed of cutting head 118 along length L of cutting surface 318 to correspond to the width of the cutting surface 318 at each waypoint 320 decreases the time required to complete the cut of cutting surface 318. When a similar process is used on each cutting surface of workpiece 300, the overall cycle time required to fabricate workpiece is reduced.

Referring again to FIG. 8, the calculation of the travel speeds of cutting head 118 is the final step in generating tool path 112. Once tool path 112 is generated, tool path generation system 110 performs 422 a computer-based simulation of tool path on a model of workpiece 300 to determine whether tool path 112 results in physical contact between workpiece 300 and cutting head 118. When it is determined that no such contact will take place, tool path generation system 110 transmits 424 tool path 112 to fluid jet cutting device 114. More specifically, tool path generation system 110 transmits tool path 112 to controller 116 coupled to fluid jet cutting device 114. As described above, in embodiments where tool path generation system 110 resides within controller 116, such transfer of tool path 112 is not required. Controller 116 then executes 426 tool path 112 causing fluid jet cutting device 114, and more specifically, cutting head 118 and cutting jet 120, to form workpiece 300 from the block of material 108. Workpiece 300 may then be further milled 428 in a multi-axis milling machine that fabricates workpiece 300 to its final operational dimensions.

The above described fluid jet fabrication system facilitates cost-effective material machining methods of interest. Specifically, in contrast to many known fabrication systems, the fabrication system as described herein generates a three-dimensional tool path for a cutting head that varies in travel speed along a length of a cutting surface. The initial steps prior to tool path generation include generating an intermediate three-dimensional model of a workpiece that is based on an operational, final model. The tool path generation process includes allocating a plurality of waypoints along an edge of a designated cutting surface and determining the width of the cutting surface at each waypoint. The maximum travel speed of the cutting head at each waypoint is then determined based on the width at each waypoint. As such, the fabrication system varies the speed of the cutting head along the length of the cutting surface to minimize the time required to fabricate the workpiece. Accordingly, the fluid jet cutting device is able to remove between approximately 60% and 70% of the total material that is to be removed from the block of material within approximately 60 minutes. As a result, the workpiece has less material to be removed by the milling machine in the final fabrication step and, therefore, reduces both cycle time and fabrication expenses.

An exemplary technical effect of the methods, systems, and apparatus described herein includes at least one of: (a) reducing the cycle time required to manufacture a workpiece by removing a majority of the material to be removed before machining the workpiece to its final dimensions; (b) reducing the manufacturing costs associated with fabricating the workpiece by reducing wear of the milling tool; and (c) increasing the number of workpieces manufactured within a given time period as compared to conventional manufacturing methods.

Exemplary embodiments of methods, systems, and apparatus for at least partially forming a three-dimensional workpiece using a fluid jet cutting device are not limited to the specific embodiments described herein, but rather, components of systems and steps of the methods may be utilized independently and separately from other components and steps described herein. For example, the methods may also be used in combination with other fabrication systems to manufacture a workpiece, and are not limited to practice with only the abrasive waterjet machining systems and methods as described herein. Rather, the exemplary embodiment can be implemented and utilized in connection with many other applications, equipment, and systems that may benefit from varying the travel speed of a cutting head along a cutting surface.

Although specific features of various embodiments of the disclosure may be shown in some drawings and not in others, this is for convenience only. In accordance with the principles of the disclosure, any feature of a drawing may be referenced and claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and any other circuit or processor capable of executing the functions described herein. The methods described herein may be encoded as executable instructions embodied in a computer readable medium, including, without limitation, a storage device and a memory device. Such instructions, when executed by a processor, cause the processor to perform at least a portion of the methods described herein. The above examples are exemplary only, and thus are not intended to limit in any way the definition and meaning of the term processor.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for forming a workpiece from a block of material using a workpiece fabrication system, the workpiece fabrication system includes a fluid jet cutting device including a cutting head and a cutting jet, the workpiece fabrication system including a processor and a memory device coupled to the processor, said method comprising:
receiving a computer generated model of the workpiece;
generating a three-dimensional tool path to control the cutting head to form the workpiece comprising:
identifying a desired cutting surface on the workpiece;
determining a length of the cutting surface;
designating a plurality of waypoints along an edge of the cutting surface;
determining at least one geometric parameter of the cutting surface at each waypoint of the plurality of waypoints; and
calculating a speed of the cutting head at each waypoint of the plurality of waypoints based on the determined geometric parameter such that the speed of the cutting head varies along the cutting surface length; and
at least partially fabricating the workpiece using the generated tool path.

2. The method in accordance with claim 1, wherein determining at least one geometric parameter of the cutting surface at each waypoint comprises determining a width of the cutting surface at each waypoint.

3. The method in accordance with claim 1, wherein receiving computer-generated model of the workpiece comprises receiving a three-dimensional computer-generated model of the workpiece.

4. The method in accordance with claim 1, wherein receiving a computer-generated model of the workpiece comprises receiving an intermediate three-dimensional computer model based on a desired final geometry of the workpiece.

5. The method in accordance with claim 1 further comprising determining positional coordinates of the cutting head at each waypoint of the plurality of waypoints.

6. The method in accordance with claim 1 further comprising determining whether the generated tool path results in physical contact between the workpiece and the cutting head.

7. The method in accordance with claim 6, wherein determining whether the generated tool path results in physical contact between the workpiece and the cutting head comprises performing a computer-based simulation of the generated tool path.

8. The method in accordance with claim 1 further comprising generating a plurality of orientation vectors to control an orientation of the cutting head, wherein each orientation vector of the plurality of orientation vectors is associated with a respective waypoint of the plurality of waypoints.

9. The method in accordance with claim 8, wherein generating a plurality of orientation vectors comprises generating the plurality of orientation vectors such that each orientation vector is parallel to the cutting surface at its respective waypoint.

10. The method in accordance with claim 1, wherein designating a plurality of waypoints along an edge of the cutting surface further comprises arranging the plurality of waypoints in a contiguous configuration such that the plurality of waypoints form a substantially solid line along the cutting surface edge.

11. A workpiece fabrication system comprising:
a fluid jet cutting device comprising a cutting head configured to generate a cutting jet of predetermined medium and to form at least a portion of a workpiece with the cutting jet; and
a processor coupled to said fluid jet cutting device, said processor configured to:
receive an indication of a geometry of the workpiece;
receive an indication of a desired cutting surface on the workpiece;
determine a length of the cutting surface;
designate a plurality of waypoints along an edge of the cutting surface;
determine at least one geometric parameter of the cutting surface at each waypoint of the plurality of waypoints; and
calculate a speed of said cutting head at each waypoint of the plurality of waypoints based on the determined geometric parameter such that the speed of said cutting head varies along the cutting surface length.

12. The system in accordance with claim 11, wherein the at least one geometric parameter of the cutting surface at each waypoint comprises a width of the cutting surface at each waypoint.

13. The system in accordance with claim 11, wherein the indication of a geometry of the workpiece comprises an intermediate three-dimensional computer model of the workpiece based on a desired final geometry of the workpiece.

14. The system in accordance with claim 11, wherein said processor is further configured to determine positional coordinates of said cutting head at each waypoint of the plurality of waypoints.

15. The system in accordance with claim 11, wherein said processor is further configured to determine whether the generated tool path results in physical contact between the workpiece and said cutting head.

16. The system in accordance with claim 15, wherein said processor is further configured to perform a computer based simulation of the generated tool path to determine whether the generated tool path results in physical contact between the workpiece and said cutting head.

17. The system in accordance with claim 11, wherein said processor is further configured to generate a plurality of orientation vectors to control an orientation of said cutting head, wherein each orientation vector of the plurality of orientation vectors is associated with a respective waypoint of the plurality of waypoints.

18. The system in accordance with claim 17, wherein each orientation vector is parallel to the cutting surface at its respective waypoint.

19. The system in accordance with claim 11, wherein the workpiece is an airfoil structure for use in a turbine engine.

20. One or more computer-readable storage media having computer-executable instructions embodied thereon, wherein when executed by at least one processor, the computer-executable instructions cause the at least one processor to:
receive an indication of a geometry of a workpiece;
receive an indication of a desired cutting surface on the workpiece;
determine a length of the cutting surface;
designate a plurality of waypoints along an edge of the cutting surface;
determine a geometric parameter of the cutting surface at each waypoint of the plurality of waypoints; and
calculate a speed of a cutting head at each waypoint of the plurality of waypoints based on the determined geometric parameter such that the speed of the cutting head varies along the cutting surface length.
